(19) United States
(12) Patent Application Publication
(10) Pub. No.: US 2015/0327513 A1
(43) Pub. Date: Nov. 19, 2015

(54) Horse leg protection devices

(71) Applicant: L.H.T. S.r.l., Piazzola Sul Brenta (PD) (IT)

(72) Inventor: Flavio CALZÁ, Campodoro (PD) (IT)

(21) Appl. No.: 14/652,765

(22) PCT Filed: Jan. 11, 2013
(86) PCT No.: PCT/IB2013/050259

§ 371 Date: Jun. 16, 2015

(30) Foreign Application Priority Data
Dec. 17, 2012 (IT) PD2012A000383

(51) Int. Cl. A01K 13/00

(52) U.S. Cl. CPC A01K 13/007

(57) ABSTRACT

A protection device for the front and rear legs of horses like splint boots, fetlock boots, and tendon boots includes a shaped body on which reinforcing elements made of titanium, or titanium alloy, are applied, with an inner layer soft rubber stitched on one or more edges of said shaped body and secured to the leg with a fastening system such as hook and loop. The related method includes the prior construction of the reinforcing elements by blanking and drawing titanium plates, their finishing treatment by zirconia alumina blasting, and subsequent passivation in an oxidation bath. The titanium elements are enveloped during the molding of the shaped body.

This patent relates to protection devices for the front and rear legs of horses and in particular concerns a novel process for the production of splint boots, fetlock boots, and tendon boots.

It is known that horses, especially those engaged in sporting events, are at greater risk of contusions on their legs. These contusions may be caused by the horse's hooves or impact with foreign objects, such as barriers during practice or competition riding.

When the horse is running, in fact, it is subject to impact in the inner part of the front and rear legs.

Moreover, in activities such as endurance, in addition to the possibility of hitting the wooden barriers, horses may also touch the fetlocks and shins while the horse walks.

For the protection of the rear legs fetlock boots are known with models made of leather or neoprene, with a Velcro or buckle closure. Other models, instead, comprise a protective part made of carbon to increase the resistance to impact with less weight and are closed with a pin and an elastic element.

As regards the forelegs, protection is provided by means of broader coverage which also protects the tendons and the interior side of the horse's shin.

Broader protection of the foreleg is a result of two different issues: the higher passage of the rear hoof on the same side and the risk for the tendon region to be reached by the rear legs.

These protectors are generally of two types: splint boots and tendon boots.

The tendon boots mainly protect the tendon by wrapping the rear and side of the leg while leaving the front exposed except for the closure straps.

These tendon boots are commonly made of neoprene and plastic.

The objective of the present invention is to provide a new type of protection boots suited to be used in those equestrian disciplines with greater risk such as cross country jumping, show jumping, endurance.

The present invention has as its objective protective devices for horse legs with reinforcing elements in titanium or titanium alloy and a new procedure for their construction.

The presence of one or more reinforcing elements made of suitably shaped titanium, or titanium alloy, confer greater resistance to accidental impacts than the current protectors on the market.

These new protectors are also very light and allow the horse to move easily and quickly.

These new protective elements, such as splint boots, fetlock boots and tendon boots, are equipped with titanium, or titanium alloy, reinforcing elements which are moulded, deep-drawn, sandblasted and passivated.

Splint boots manufactured according to the new procedure include the construction of a shaped body made of semi-rigid rubber with titanium or titanium alloy reinforcing elements positioned both longitudinally and transversely to said body.

The base structure of the splint boot is then coated on the inside with neoprene material so that this softer part is suited to be in contact with the horse's leg.

This splint boot is secured around the horse's leg by means of a Velcro closure.

The fetlock boots and tendon boots, constructed according the new process, comprise a semi-rigid rubber body with titanium or titanium alloy reinforcing elements positioned transversely or longitudinally with respect to the rigid shaped body.

The fetlock boots are trimmed and finished with soft rubber sewn on the neoprene. The semi-rigid rubber body, for this different type of protector, is also coated with a layer of neoprene in the inner surface so that the protective neoprene is in contact with the horse's leg.

The fetlock boot is secured around the horse's leg with a Velcro closure.

This type of protection devices, therefore, is lighter for the horse and has more rigidity to protect against blows or impacts suffered by the horse in its activities.

To achieve this result, a method for the manufacturing of these protectors for the horse's legs was developed comprising several phases.

The first phase includes the construction of titanium or titanium alloy reinforcement elements by means of the blanking and drawing of titanium plates.

In the second phase the titanium or titanium alloy reinforcing elements are subjected to a sand-blasting finishing treatment using zirconia alumina, and subsequent passivation in an oxidation bath.

In the third phase, the titanium or titanium alloy reinforcing elements are entirely or partly inserted or enveloped in a rubber support by means of injection moulding.

The shaped rubber body comprising the titanium or titanium alloy reinforcing elements thus treated and enveloped, is subsequently internally lined with neoprene material and trimmed with soft rubber sewn on the neoprene.

The soft inner neoprene side comes in contact with the horse's leg.

The characteristics of the new protectors will be better clarified by the following description with reference to the drawings, attached by way of a non-limiting example.

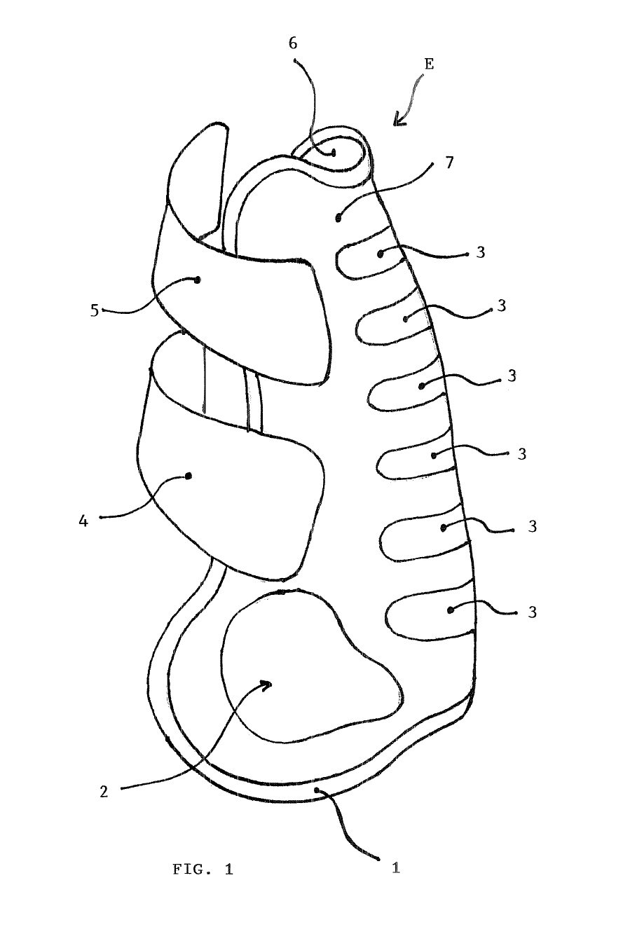

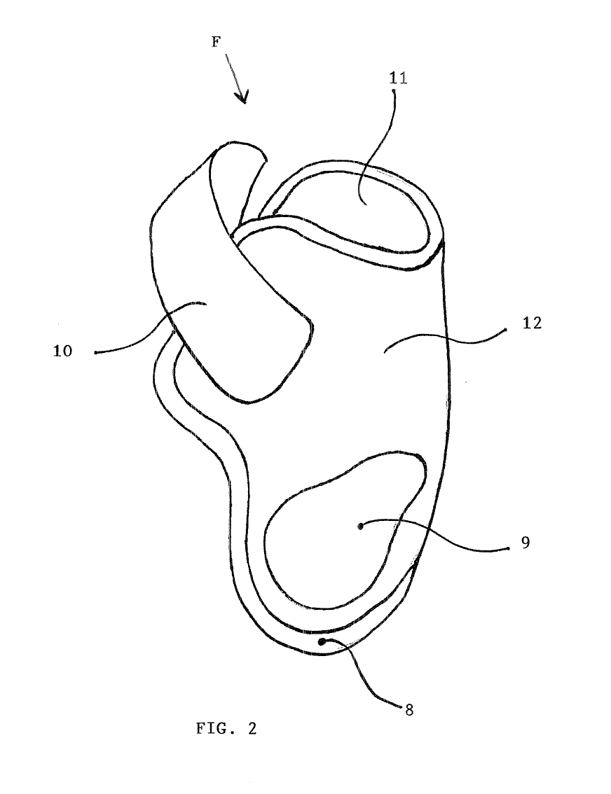

The attached drawings contain two FIGS. 1 and 2, relating to a practical embodiment of a splint boot (E) and a fetlock boot (F).

FIG. 1 shows a splint boot (E) constructed with the new procedure.

This splint boot (E) comprises a semi-rigid rubber body (7) shaped and suited to wrap the horse's leg around its shin.

This shaped body (7) comprises reinforcing elements (2, 3) positioned longitudinally and/or transversely made of titanium, or titanium alloy, suited to provide greater rigidity and resistance to the protector. The rubber body comprises an edge (1) made of soft rubber sewn on a neoprene lining.

This body is applied to the horse's leg by means of Velcro closures (4, 5).

FIG. 2 shows a fetlock boot (F) constructed with the new procedure.

This fetlock boot (F) comprises a semi-rigid rubber body (12) where along the length of the entire body reinforcing elements (9) made of shaped titanium or titanium alloy are applied. The rubber body (12) comprises an edge (8) made of soft rubber sewn on the neoprene lining and a Velcro closure system (10).

The fetlock boot (F) is also lined on the inner surface with neoprene material (11), so that this softer part comes in contact with the horse's leg.

These results are obtained by applying the following procedure:
construction of the reinforcing elements (2, 3, 9) in titanium by blanking and drawing titanium sheets;
sand-blasting using zirconia alumina as medium for the finishing treatment of the reinforcing elements (2, 3, 9) made of titanium and their subsequent passivation in an oxidation bath;
construction of the rubber support (7, 12) by injection moulding with the envelopment in whole or in part of said reinforcing elements (2, 3, 9) made of titanium or titanium alloy;
application of the neoprene inner lining of the rubber support (7, 12) and the soft rubber edge (1, 8) of the support.

These are the basic outlines sufficient for the skilled person to manufacture these new protectors. Consequently, the practical application may include variations without prejudice to the substance of the innovative concept.

Therefore, with reference to the preceding description and the attached drawings, the following claims are made.

The invention claimed is:

1. A protection device for a front or rear leg of a horse comprising:
a shaped body in accordance with horse leg anatomy;
reinforcing elements made of titanium, or a titanium alloy, coupled to an outer wall of said shaped body; and
an inner padding layer coupled to an inner wall of said shaped body.

2. The protection device, according to claim 1, wherein said reinforcing elements made of titanium, or a titanium alloy, are applied on said shaped body longitudinally and/or transversely, and wherein said inner padding layer is made of soft rubber and is sewn on one or more edges of said shaped body.

3. The protection device, according to claim 2, wherein said reinforcing elements made of titanium, or a titanium alloy, are enveloped entirely or partly in said shaped body.

4. The protection device according to claim 1, further comprising hook and loop based closure devices configured to wrap around the horse's leg.

5. A process of producing protectors for front and rear legs of horses according to claim 1, the process comprising:
providing reinforcing elements in titanium or a titanium alloy by blanking and drawing titanium sheets;
sand-blasting said reinforcing elements using zirconia alumina as a medium for a finishing treatment of the reinforcing elements made of titanium or a titanium alloy and subsequently passivating said reinforcing elements in an oxidation bath;
providing a rubber support by injection molding by at least partially enveloping said reinforcing elements made of titanium or a titanium alloy, treated as in the preceding step; and
applying a layer of neoprene and a soft rubber edge on an inner lining of the rubber support.
